(19) United States
(12) Patent Application Publication
(10) Pub. No.: US 2026/0054510 A1
(43) Pub. Date: Feb. 26, 2026

(54) MANUFACTURING AND DEPLOYMENT OF PRINTED DEVICES USING MACHINE LEARNING

(71) Applicant: Purdue Research Foundation, West Lafayette, IN (US)

(72) Inventors: Jan P. Allebach, West Lafayette, IN (US); Muhammad Ashraful Alam, West Lafayette, IN (US); Rahim Rahimi, West Lafayette, IN (US); Babak Ziaie, West Lafayette, IN (US); Ali Shakouri, West Lafayette, IN (US); Mukerrem Cakmak, Lafayette, IN (US); Nicholas Glassmaker, West Lafayette, IN (US); Xihui Wang, West Lafayette, IN (US); Qingyu Yang, San Jose, CA (US)

(21) Appl. No.: 19/379,362

(22) Filed: Nov. 4, 2025

Related U.S. Application Data
(62) Division of application No. 17/573,385, filed on Jan. 11, 2022, now abandoned.
(60) Provisional application No. 63/136,163, filed on Jan. 11, 2021.
(60) Provisional application No. 63/142,606, filed on Jan. 28, 2021.

(51) Int. Cl. B41M 3/00

(52) U.S. Cl. CPC B41M 3/00

(57) ABSTRACT

Methods for fabricating printed devices and monitoring one or more performance characteristics of the printed devices during their fabrication in a high-speed process. Such a method includes developing a physics-based model of at least a first component of the printed devices, fabricating the printed devices with the high-speed process using fabrication steps that comprise depositing the first components, acquiring a physical characteristic of a plurality of the first components of a plurality of the printed devices following the depositing of the first components, predicting a performance characteristic of the printed devices based on the physics-based model of the first component and the physical characteristic acquired of the plurality of the first components; and then modifying at least one of the fabrication steps performed during the fabricating of a subsequently-fabricated group of the printed devices to adjust the performance characteristic of the subsequently-fabricated group of the printed devices.

### CROSS-REFERENCE TO RELATED APPLICATIONS

This is a division patent application of co-pending U.S. patent application Ser. No. 17/573,385 filed Jan. 11, 2022, which claims the benefit of U.S. patent application Ser. Nos. 63/136,163 filed Jan. 11, 2021, and 63/142,606 filed Jan. 28, 2021. The contents of these prior patent applications are incorporated herein by reference.

### BACKGROUND OF THE INVENTION

The present invention generally relates to printed devices, including electronic, optical, and optoelectronic devices, and their fabrication. The invention particularly relates to printed devices and methods of collecting information from the devices during their fabrication to predict their performance in the field and using field performance data to modify the fabrication process. The methods can be utilized for printed devices that are fabricated by high-speed processes, including but not limited to roll-to-roll (R2R) systems and sheet-to-sheet systems, and feedback from field performance data is used to modify the fabrication process in real-time.

There are ongoing efforts to develop the ability to manufacture relatively low-cost Internet of Things (IoT) sensors and actuators that can be produced at mass volumes and widely deployed. One such approach is to manufacture such devices using a roll-to-roll (R2R) system (also known as web processing, or reel-to-reel processing). Generally, an R2R process fabricates devices by printing or otherwise applying parts or an entire device on a flexible substrate, for example, a plastic film or metal foil, which is dispensed from a roll into the R2R system and then re-reeled into a roll at the end of the R2R process. A major challenge is to efficiently and economically monitor device quality during the fabrication process with a R2R system in real-time. Because of the continuous printing process involved in R2R manufacturing, it is necessary to monitor device quality and make rapid adjustments to the process control parameters during fabrication.

FIG. 1 schematically represents a nonlimiting example of a thin-film nitrate sensor of a type that can be used in agriculture to monitor soil conditions. The particular sensor represented is a potentiometric nitrate sensor that has an ion-selective (or sensitive) membrane (ISM) to detect nitrate levels. The sensor can be fabricated on a R2R system by printing an electrode on a polymer substrate, as a nonlimiting example, a polyethylene terephthalate (PET)) film, and then coating the electrode with the ion-selective membrane and a passivation layer, as indicated in FIG. 1.

The electrode region coated with the ion-selective membrane is the active region of the nitrate sensor and draws the most attention in terms of the performance of such a sensor. Studies of nitrate sensors have indicated that there is a correlation between sensor performance and the non-uniform coating of the ion-selective membrane, which in turn is determined by process control parameters. Physical analysis has indicated that variations in the surface roughness of the ion-selective membrane is challenging to quantify. In a R2R system, variations in the characteristics of a printed ion-selective membrane on a printed electrode are inevitable.

Consequently, in order to fully take advantage of the processing efficiencies of R2R and other high-speed systems, it would be highly desirable to monitor device performance in real time to ensure the quality of the device s as they are being fabricated. Such a capability would not only be useful for nitrate sensors, but also other types of devices that are capable of being fabricated using R2R systems or other high-speed systems capable of fabricating such devices on a substrate.

### BRIEF SUMMARY OF THE INVENTION

The present invention provides methods suitable for fabricating printed devices, including electronic, optical, and optoelectronic devices.

According to one aspect of the invention, a method is provided for monitoring a performance characteristic of printed devices during fabrication of the printed devices in a high-speed process. The method includes developing a physics-based model of at least a first component of the printed devices, fabricating the printed devices with the high-speed process using fabrication steps that comprise depositing the first components, acquiring a physical characteristic of a plurality of the first components of a plurality of the printed devices following the depositing of the first components, predicting a performance characteristic of the printed devices based on the physics-based model of the first component and the physical characteristic acquired of the plurality of the first components; and then modifying at least one of the fabrication steps performed during the fabricating of a subsequently-fabricated group of the printed devices to adjust the performance characteristic of the subsequently-fabricated group of the printed devices.

Technical aspects of the invention as described above preferably include the ability to monitor device performance in real time while being fabricated using a high-speed process to ensure the quality of devices.

Other aspects and advantages of this invention will be appreciated from the following detailed description.

### BRIEF DESCRIPTION OF THE SEVERAL VIEWS OF THE DRAWING

FIG. 1 schematically represents a nitrate sensor of a type that can be manufactured by a roll-to-roll (R2R) process in accordance with a nonlimiting embodiment of this invention.

FIG. 2 is a schematic of a R2R thin-film system equipped with data acquisition, feedback, and feedforward subsystems in accordance with a nonlimiting embodiment of this invention.

FIGS. 3A, 3B, and 3C represent systems for performing real-time in-line measurements of thin-films (FIG. 3A) to acquire thicknesses (FIG. 3B) and refractive indices (FIG. 3C) of the thin films using confocal and capacitive sensors.

FIG. 4 is a flow chart representing a method of monitoring a performance characteristic of electronic devices during fabrication of the electronic devices on a R2R system.

FIG. 5 schematically represents a method of segmenting an active region of a nitrate sensor using a template matching method.

FIG. 6A schematically represents an experimental setup for measuring actual performance (voltage) of nitrate sensors, and FIG. 6B is a graph plotting voltage measurements of a nitrate sensor using the setup represented in FIG. 6A.

FIG. 7 is a flow chart representing a procedure for fitting a saturated sensor performance curve into the logarithmic function and generate ground truth parameters.

FIG. 8 schematically represents a prediction system constructed to predict sensor performance based on active region images of nitrate sensors.

FIG. 9 schematically represents an in-line system of predicting the performance of a nitrate sensor based on 2D images of the device at iteration t.

FIG. 10 schematically represents a four-layer FC network, whose input Xinput is a flattened image.

FIG. 11 is an example of two basic blocks in sequence of a residual learning technique that inserts a skip connection between each block of convolutional layers.

FIG. 12 schematically represents a ResNet-34 network structure for online sensor image assessment, and represents the network structure as split into for stages, and each generating feature maps with different number of channels.

FIG. 13A depicts examples of active-region images of nitrate sensors from different manufacturing runs (off-line and in-line), FIG. 13B is a graph plotting potentiometric voltage responses for nitrate sensors from an off-line manufacturing run, and FIG. 13C is a graph plotting potentiometric voltage responses for nitrate sensors from an on-line manufacturing run.

FIG. 14 compares the adaptive abilities of three curve fitting methods: ResNet+BP, FC+HBP, and ResNet+HBP, plotting RMSE between prediction and ground truth for forty-five nitrate sensors in on-line settings.

FIG. 15 schematically represents a R2R system that includes the use of electric and magnetic fields to organize nano/micro columns of dielectric and magnetic particles in a polymer matrix precursor, and FIG. 16 schematically represents the use of metrology tools to assess local density of the nano/micro columns created with the system of FIG. 15.

### DETAILED DESCRIPTION OF THE INVENTION

The intended purpose of the following detailed description of the invention and the phraseology and terminology employed therein is to describe what is shown in the drawings, which relate to one or more nonlimiting embodiments of the invention, and to describe certain but not all aspects of what is depicted in the drawings, including the embodiment(s) to which the drawings relate. The following detailed description also describes certain investigations relating to the embodiment(s) and identifies certain but not all alternatives of the embodiment(s). The following detailed description also describes certain investigations relating to the embodiment(s) and identifies certain but not all alternatives of the embodiment(s). Therefore, the appended claims, and not the detailed description, are intended to particularly point out subject matter regarded as the invention, including certain but not necessarily all of the aspects and alternatives described in the detailed description.

The following disclosure describes various aspects of systems, subsystems, and methods suitable for collecting information from devices during their fabrication to predict their performance in the field and using performance data to modify the fabrication process. The disclosure particularly describes various aspects of roll-to-roll (R2R) and other methods for fabricating printed devices and the use of feedback from performance data to modify the fabrication process in real-time. Though the following discussion will particularly describe investigations for producing sensing devices using R2R processes, the disclosure also encompasses other types of devices produced using other processes. As such, the term “printed device” is used herein to mean a wide variety of electronic, optical, mechanical, biological, electromechanical, optomechanical, and optoelectronic devices, including sensors and actuators, whose fabrication involves the deposition or processing of at least one layer of the device using one or more printing, coating, laser processing, annealing, or other thin-film or thick-film processing or deposition techniques. Furthermore, the term “high-speed process” will be used to refer to R2R, sheet-to-sheet, and other continuous processes capable of producing printed devices at mass volumes.

Nonlimiting aspects of this disclosure include the following: printed devices, including but not limited to sensors capable of sensing various physical, chemical, and biological parameters; the fabrication of such devices using R2R or another high-speed process; high-speed control of such a process; physics-based model-guided in-line characterization and physics-based machine learning (ML) models for performance (functional) characterization of the printed devices; and statistical methods for developing reliable sensing capabilities with mass-produced devices that, due to the fabrication method used, may result in some of the devices being unreliable.

In order to be competitive with devices made by higher-cost, more advanced manufacturing systems, high-speed processes (including but not limited to R2R and sheet-to-sheet manufacturing processes) must balance a trade-off between accuracy and speed. The benefit of speed (thus low cost) is lost if each device must be tested and packaged for functional accuracy before field deployment. This disclosure is intended to account for shortcomings inherent in R2R and other high-speed processes and to avoid post-manufacturing device testing by adopting in-line surrogate tests enabled by the physics-based ML models to eliminate the need for individual device testing.

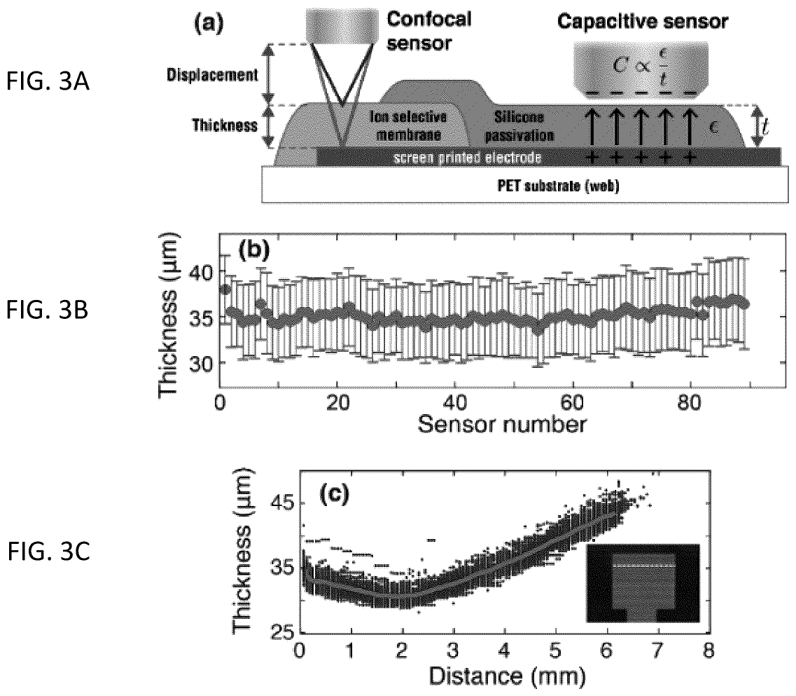

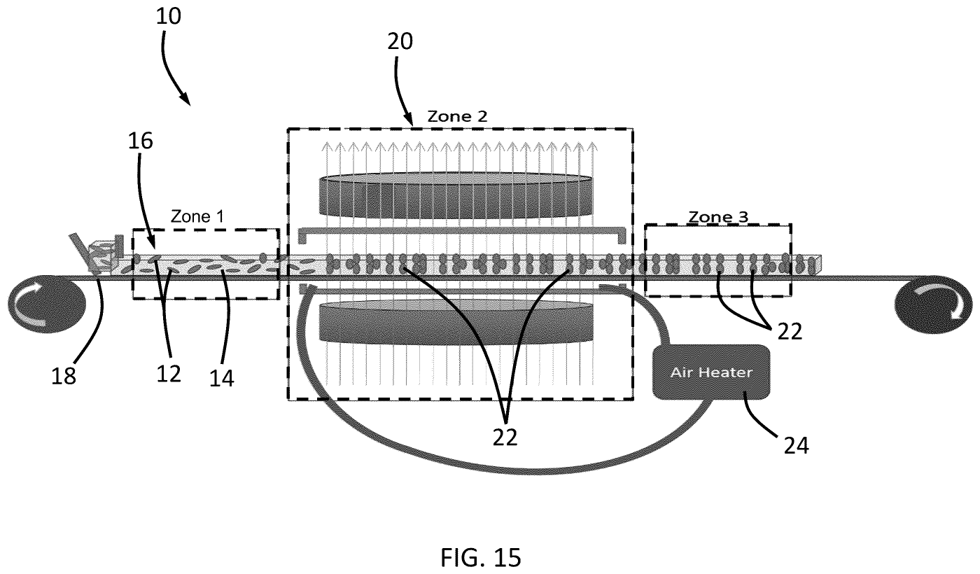

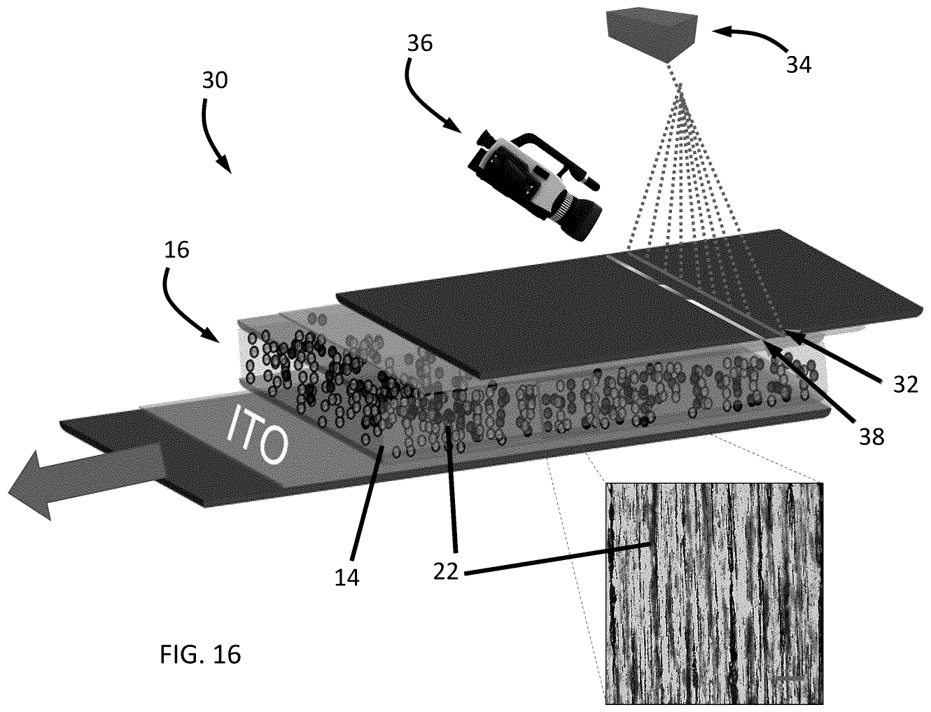

High-speed monitoring of an R2R process (or other high-speed process) in real-time is required for characterizing, automatic feedback, and tuning of process parameters of printed devices and to enable the development of surrogate models that can predict and estimate the performance of the devices. The characterization system is preferably non-contact and able to efficiently acquire one or more physical characteristics of one or more printed devices, such as but not limited to measuring morphological and material parameters, which can be correlated to one or more performance characteristics of the devices. High-speed monitoring for physical characterization of a printed device may include line-scan cameras, confocal, and capacitive sensors (FIG. 3A). Such imaging and measurements can be synchronized to web motion of an R2R system by high-precision mechanical encoding and optical sensors and triggered by discrete devices or fiducial marks. Web and surface morphologies of devices can be imaged and measured with line-scan cameras, confocal and capacitive sensors can be used to measure thicknesses and/or dielectric constants of films and the height of metallic films with submicron axial and lateral resolutions (FIGS. 3B and 3C), and optical birefringence/light transmission tools can be used to determine stress levels as well as orientations of the formation of structures particularly in a magnetic field zone (FIGS. 15 and 16). Calibration and validation of measured parameters can make use of off-line secondary instrumentation measurement systems to validate in-line measurements. A park-and-go strategy can be employed in which the web of an R2R system runs continuously but can be buffered in a combined isolation accumulator loop such that sections of the web can be parked on a vibration-isolated stage using vacuum, interrogated, and then released by air floatation without impacting web travel in other sections of the R2R system.

Using in-line metrology and multi-sensor analytics as integral parts of a manufacturing process can lead to the generation of voluminous amount of data that are saved and analyzed. In contrast, the present disclosure uses physics-based models of printed devices to select subsets of devices while resident within an in-line manufacturing process to serve as a surrogate in-line quality monitor, tests of individual off-line devices (after completion of their manufacturing) to assess the ultimate functionality of the devices, and uses a physics-based machine learning (ML) model (with inputs from the physics-based models of the printed devices, the data collected by in-line devices, and the results of the off-line functional test data) to eliminate the need for post-manufacturing testing. These concepts were demonstrated with R2R-printed resistors and nitrate sensors during investigations leading up to the present invention. For example, a physics-based model for potentiometric nitrate sensors (e.g., ψ(n,t)=f(n,D,μ,h) was utilized to identify variables that dictate sensor function, namely, the thickness (h), dielectric constant (ε), and mobility of ions (μ) within the ion selective or sensitive (hereinafter, ion selective) membrane of the sensor. The corresponding sensors can be imaged and characterized for thickness and morphology, capacitance (for dielectric constant), and solid-content in the solution (as a proxy for ion diffusivity). Once the electrical tests are completed, the physics-based ML model can be used to integrate the images, capacitance results, and R2R process parameters to predict the performance characteristics of the sensor. Once trained, the ML model can serve as the surrogate quality monitor of the process, such that exhaustive device-by-device testing is unnecessary.

On the basis of the above, nonlimiting aspects of the invention are directed to the manufacturing and deployment of reliable yet relatively low-cost printed devices using the following steps: fabrication of printed devices using a continuous printing (or other deposition or processing) step to form at least one component of the devices, in-line physical characterization of at least one physical characteristic of at least some of the in-line printed devices using machine learning algorithms, feedback control to alter the fabrication of subsequently-fabricated devices based on the in-line physical characterization of the in-line printed devices and machine learning algorithms, and physics-based models of performance characteristics of the devices to predict device performance and improve the machine learning algorithms. In the case of R2R manufacturing, measurements and/or images are continuously obtained on a moving web and the results together with the physics-based models are used to adjust future or past processing steps, referred to herein as feed forward or feed backward, respectively. In the case of sheet-to-sheet manufacturing, measurements and/or images are obtained for each sheet and the results together with the physics-based models are used to adjust future or past sheet processing.

The fabrication of the printed devices may include fabricating electrodes of the devices (for example, by screen printing, inkjet printing, laser cutting), depositing (printing, coating, etc.) one or more layers of the devices that influence the performance characteristics of the devices (as a nonlimiting example, an ion selective membrane of a nitrate sensor), and treatments performed on the printed devices (as nonlimiting examples, drying, annealing, sintering, heat treating, curing, etc.).

The in-line physical characterization of the printed devices preferably utilizes non-contact methods of acquiring physical characteristics of the devices. Suitable non-contact methods include but are not limited to imaging of at least some and preferably each device and at least some and preferably each fabrication step using images of the devices obtained with one or more linescan cameras and/or color/multi spectral cameras, and/or using local measurements of the devices, for example, capacitance, confocal, Eddy current, dielectric constant, conductance, spectroscopic reflectance, film thickness, ellipsometric measurements, etc. Machine learning algorithms are then applied to the acquired in-line physical characterizations of the devices.

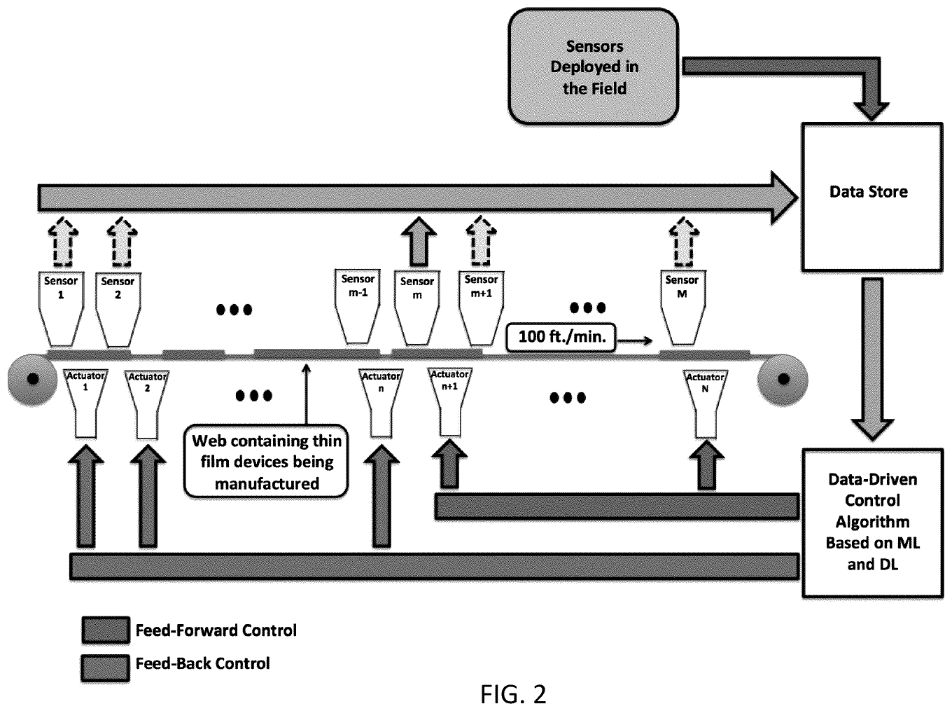

Feedback control can be implemented by repeating the fabrication and in-line physical characterization steps for a plurality of the printed devices and, using machine learning algorithms, adjusting one or more of the fabrication steps based on a previous in-line physical characterization step and and/or adjusting one or more of the fabrication steps based on field data and/or other off-line measurements performed on previous batches of the devices. Feedback signals can be sent to previous (feed backward) and future (feed forward) manufacturing steps, as represented in FIG. 2. Feedback control can be used to adjust a wide variety of fabrication steps and parameters, including but not limited to adjusting the flow rate, viscosity, temperature for slot die, gravure, screen printing, or other coating steps to modify the thickness of one or more deposited layers, selectively adding additional layers to control the overall thickness, surface roughness, or microstructure of one or more deposited layers, adjusting laser processing or flash annealing/sintering parameters (pulse duration, intensity, wavelength) of one or more deposited layers, adjusting heat treatment parameters (temperature, duration, humidity control, etc.) of one or more deposited layers, adjusting inkjet printing or droplet deposition parameters (droplet volume, frequency, etc.) of one or more deposited layers, and dynamic adjustments to the web speed. Depending on web speed, fast image processing and artificial intelligence (AI) algorithms in milliseconds down to microseconds or lower may be desirable to be able to implement real-time feedback control.

Physics-based models of the printed devices correlated to their performance are developed to improve machine learning algorithms by introducing physical constraints into the algorithms. These models include predictive modeling of sensor output versus time, sensor output versus one or more fabrication parameters, etc.

Off-line characterization of physical characteristics of one or more individual off-line devices (after completion of their manufacturing) is performed to assess the ultimate functionality of the devices produced by the fabrication process. Such physical characteristics may include device output (voltage, color, etc.) versus time (performed on devices fabricated during different fabrication runs and/or performed at different ambient conditions such as temperature, humidity, etc.), device output versus concentration (sensitivity), and device selectivity (testing the selectivity or sensitivity of a device to different solutions, chemicals, compounds, etc.,). Physical characterization of the devices can be performed before and after the off-line characterization tests to identify variations in microstructure or physical parameters, impact of water layer formation, etc.

Finally, field measurements of the printed devices can be performed to evaluate device output (voltage, color, etc.) versus time (hours to months). Any number if measurements can be formed on any number of devices at any given location and taken under a variety of ambient conditions (temperature, light, humidity, etc.).

Nonlimiting embodiments of the invention will now be described in reference to experimental investigations leading up to the invention.

### Thin-Film Nitrate Sensor Performance Prediction Based on Pre-Processed Sensor Images

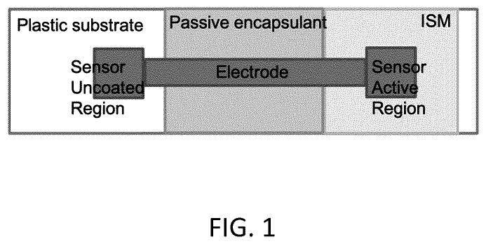

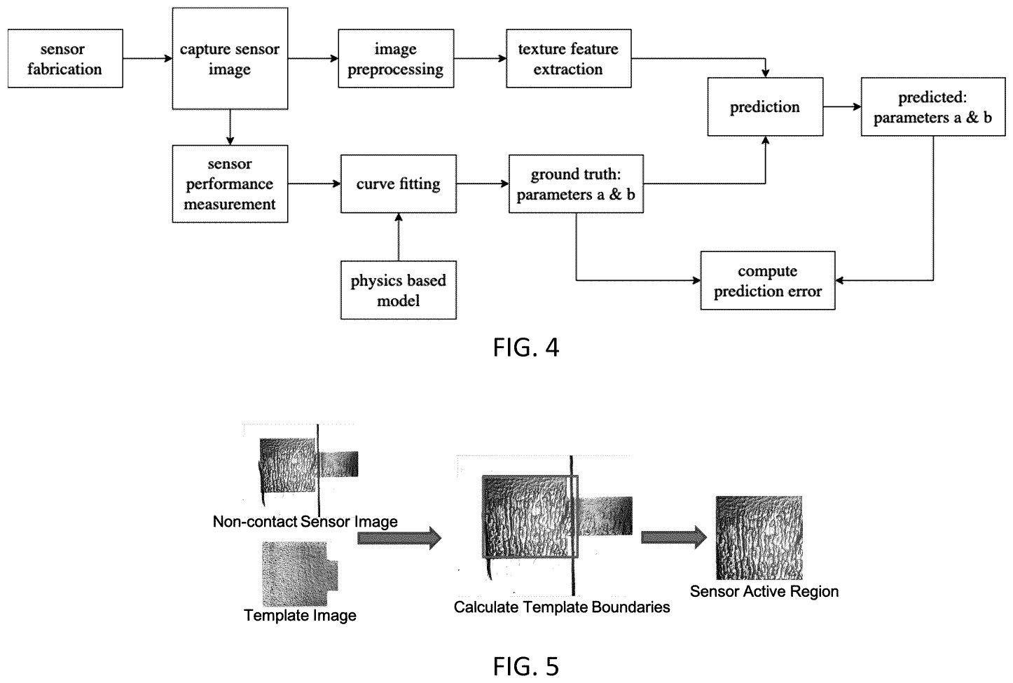

FIG. 4 schematically represents a sensor performance prediction system based on non-contact images of nitrate sensors of the type shown in FIG. 1. An R2R manufacturing system was used to fabricate the nitrate sensors by printing an electrode for the sensors on a polyethylene terephthalate (PET) substrate and coating the electrode with an ion sensitive membrane (ISM) and a silicon passivation layer, as shown in FIG. 1. The active regions of the nitrate sensors were their electrode regions coated with the ion sensitive membranes. The images of the sensors that were fed into the prediction system of FIG. 4 were of the active regions captured using an electro-optical system (EOS) camera with a microscope. A non-uniform ISM significantly impacts sensor performance and also alters the surface appearance of the active region, providing mathematical confidence for the prediction system to associate the sensor performance data with extracted texture features from the non-contact sensor images. The sensor active regions were immersed in a nitrate solution to assess off-line sensor performance.

Both machine learning and deep learning approaches were considered when designing the prediction system. A logarithmic function was proposed based on a physics-based model to represent the sensor performance. The local binary pattern (LBP) visual descriptor and pre-trained convolutional neural network (CNN) were used to extract texture features from the sensor images. Manufacturing factors were also fused into the system along with image features.

The investigation expanded on image-based prediction systems by focusing on preprocessing the sensor active region images to achieve better accuracy on the predicted sensor performance curve. A template matching method was implemented to segment the sensor active region from the non-contact image in the image data preparation step. A contrast limited adaptive histogram equalization (CLAHE) technique was applied to enhance texture contrast in the sensor active region images. A Gaussian pyramid method was investigated as a multiscale approach to extract texture features from sensor images.

### Dataset Preparation

Sensor active region images and their ground truth data are required for the image-based prediction system. Before training the prediction model of FIG. 4, the sensor active region images and the ground truth data were generated separately.

### Image Data Preparation

As noted above, the texture appearance of the active region of a nitrate sensor is a physical characteristic that is related to its performance characteristics. Therefore, the sensor active region is cropped out of the original non-contact sensor image to avoid distractions to the prediction system. With the increasing amount of sensors fabricated under varying settings, separating the sensor active region from its background can be challenging. In this case, an efficient and stable way to segment the sensor active region using the template matching method was used, represented in FIG. 5.

The template matching technique of FIG. 5 was intended for inspecting the source image and locating the area that best matched the object presented in the template image by minimizing the mean-squared error or maximizing area correlation. In this case, the template matching algorithm gave the best performance when a color sensor image was transferred into an R-channel grayscale image using a correlation coefficient method.

### Ground Truth Data Preparation

The image-based prediction system is expected to predict the overall potentiometric response of the nitrate sensors. Therefore, the ground truth data should be the parameters that represent the entire sensor performance data. The physics-based model provided a logarithmic function representing the sensor performance signal, which simplified the ground truth data into two parameters, which were named performance parameters.

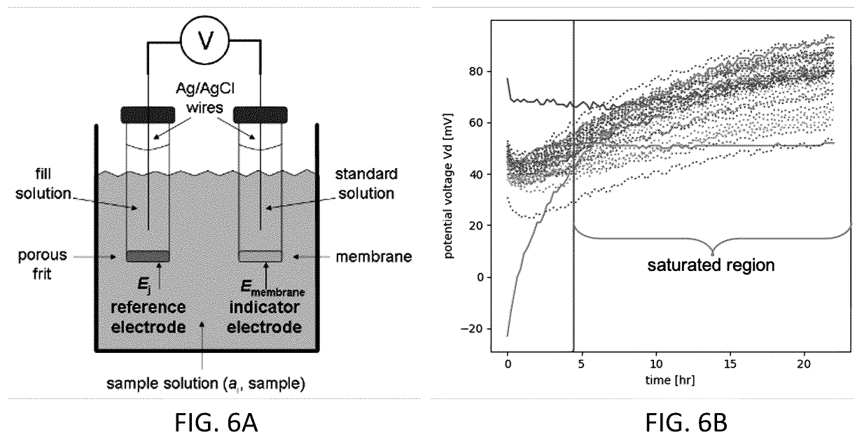

FIG. 6A schematically represents an experimental setup for measuring the performance characteristics of the nitrate sensors. The working electrode (WE) potential of a nitrate sensor depends on nitrate ion concentration, and its ISM ensures that only the nitrate ion impacts the WE potential. The reference electrode (RE) provides a stable reference electrochemical potential via the solid electrolyte coating. The sensor performance data is the potential difference between the WE and the RE.

FIG. 6B provides an example of a sensor performance curve for one sensor set measuring a 0.001 molar nitrate solution for twenty-two hours. After about 4.5 hours, the potentiometric response achieves a saturated phase, and this is the phase that is applied to the physics-based model. It is worth mentioning that the solid line signals are the outliers caused by experimental error and are eliminated when training the prediction system of FIG. 4.

The physics-based model suggested that the change of potential voltage over time was a logarithmic growth. Therefore, the saturated region of the sensor performance curve was fitted to Equation 1 below. The parameters a and b are the performance parameters that represented the sensor performance curve after saturation.

$${V}_{fit} ( t ) = a \cdot log ( t ) + b \qquad ( 1 )$$

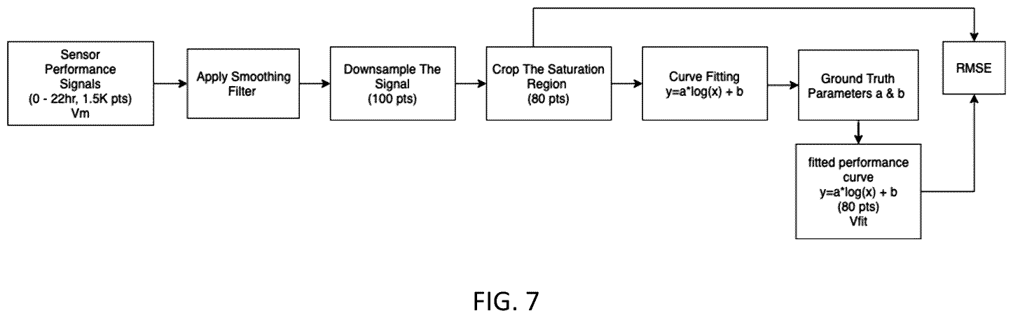

The procedure to fit the saturated sensor performance curve into the logarithmic function and generate the ground truth parameters is represented in FIG. 7. The measured sensor performance signal is denoted as Vₘ and a smoothing filter was applied to Vₘ. The smoothing filter used was the 5th order Savitzky-Golay filter, and the filter window length was equal to 100 data points. The smoothed signal was downloaded from around 1.5k data points to 100 data points and the downsampled signal was denoted as V_{d}. The saturated region of V_{d} was the last 80 data points. After that, the Levenberg-Marquardt algorithm was used to find the best fitted logarithmic curve for the saturated region of V_{d}. The fitted logarithmic curve was denoted as V_{fit}.

In Equations 2 and 3, the root-mean-square error (RMSE) is calculated to evaluate the accuracy of the fitted curve.

$$R M S {E}_{C F} ( mV ) = \sqrt{\frac{1}{N} {\sum }_{x} {( {V}_{fit} ( x ) − {V}_{d} ( x ) )}^{2}} \qquad ( 2 )$$

$${RMSE}_{C F} ( \% ) = \sqrt{\frac{1}{N} {\sum }_{x} {( \frac{{V}_{fit} ( x ) - {V}_{d} ( x )}{{V}_{d} ( x )} )}^{2}} \times 100 \% \qquad ( 3 )$$

where CF stands for curve fitting process, and N is the total number of time points.

The dataset generated contained 108 sensors. The performance data of those sensors was measured in a 0.001 molar nitrate solution for twenty-two hours. The average RMSE for the curve fitting process was around 1.2980 mV or 1.5231%. The result indicated that using two performance parameters as ground truth data to represent the saturated region of the sensor's potentiometric response was reliable.

### Image Preprocessing

The connection between the texture feature of the sensor active region image and sensor performance data was the cornerstone for the image-based prediction system. Therefore, an approach was proposed using the contrast limited adaptive histogram equalization (CLAHE) method to improve the visibility level of the texture feature of the active region image.

CLAHE is a variant of adaptive histogram equalization (AHE), which improves local contrast and enhances the edges in each region of an image and prevents overamplification of noise. The RGB color space of the active region sensor image is nonlinear since gamma correction is applied when capturing the sensor image. Hence there was a need to degamma correct the image and then apply CLAHE on the linear color space. Experiments showed that the CLAHE worked best on the L* channel. Two parameters are required for the CLAHE method. ClipLimit sets the threshold for contrast limiting, and tileGridSize represents the number of tiles in the row and column. Here, the ClipLimit was set to 3 and tileGridSize was set to 8×8. After the enhancement, the gamma correction was applied to the enhanced image for display.

### Texture Feature Extraction

As noted above, the non-uniform coating of an ISM during the sensor fabrication process causes visual differences in the sensor active region image. It is necessary to extract meaningful features from the active region sensor image that describe the texture properties. This following focuses on the local binary patterns (LBP) method, and the combinational method of LBP and the Gaussian pyramid method.

LBP is a powerful texture operator and plays a vital role in the study of pattern classification in computer vision. Various methods have been developed since the default method of LBP was first proposed. The present investigation focused on the application of the uniform method and the nri_uniform method of LBP. The uniform method of LBP is grayscale and rotation invariant for uniform patterns, while the nri_uniform method is only grayscale invariant. The pattern is called uniform if the binary array contains at most two bitwise transitions from 0 to 1 or vice versa.

Two parameters are essential for generating the LBP of an image. P represents the number of circularly symmetric neighbor points, and R defines the radius of the neighbor circle around the target pixel. With the same parameter setting, the generated LBP histograms are entirely different for the uniform method and the nri_uniform method.

The Gaussian pyramid method is often used as a multiscale image processing technique. A Gaussian filter was applied to the images and then the images were downsampled, so that the resolution for each layer was one-fourth of the previous layer. In the investigations, the Gaussian pyramid contained three layers (layer0, layer1, and layer2), and the original sensor active region image was denoted as layer0. The image size for each layer was555×555 pixels, 278×278 pixels, and 139×139 pixels. The combinational method is to apply the LBP method on each layer of the Gaussian pyramid to extract texture features over different scales.

### Prediction Models

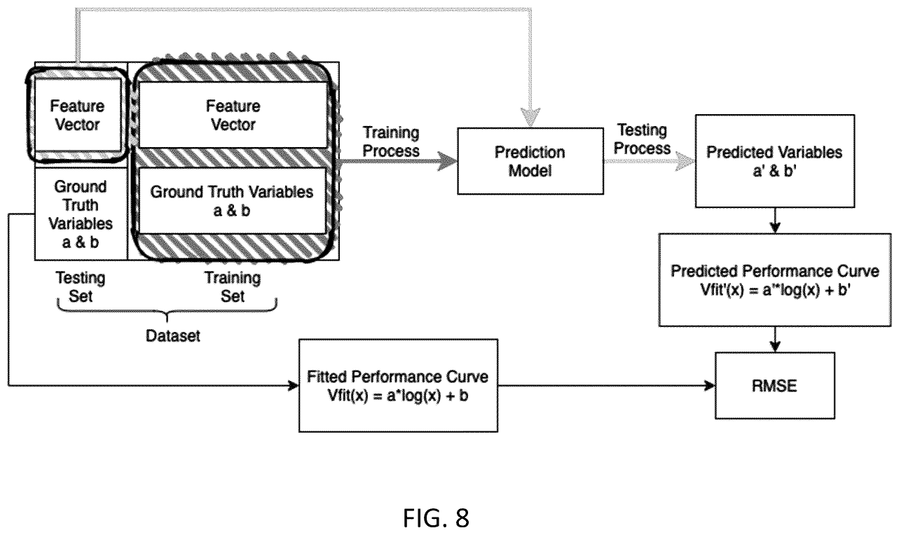

The prediction system was constructed to predict sensor performance based on active region images. As noted above, the performance parameters a and b can represent the potentiometric response in the saturated region. The support vector regression (SVR) model and a CNN-based regression model were selected to be the prediction model. The system took the generated performance parameters and the texture features extracted from the sensor image as input during the training process for the SVR model. To test the accuracy of the prediction model, the system took the feature vector as input and output the predicted performance parameters during the testing process. For the CNN-based regression model, the input for the system was the sensor image instead of texture features. The structure of this image-based prediction system is shown in FIG. 8.

The SVR model finds an appropriate hyperplane in higher dimensions to fit the input data by setting the proper hyperparameters. The radial basis function (RBF) kernel was used in the SVR model because of the non-linear relationship between the feature vector and the performance parameters.

The deeper network can learn more complex features from the image in the convolutional layers, but gradients would become infinitely large or zero and fail the training if the network contains too many layers. The residual network provided an idea to overcome the vanishing gradient problem by using skip connections. Hence, the architecture of ResNet-34 was selected for the CNN-based regression model. Two modifications were made. The number of neurons in the fully connected output layer was adjusted to be two. The loss function was replaced by the L2 loss between the predicted performance curve and the fitted performance curve.

### Experiment Results

As noted above, the dataset used in this experiment contained 108 sensors. To get a reliable estimate of the system performance, the 5-fold cross validation procedure was followed to train and evaluate the prediction system. The number of sensors in each fold was 22, 22, 22, 21, 21. The system was trained on four folds and evaluated the remaining one fold each time. When all folds were evaluated exactly once, the average performance across all five folds was taken as the system performance.

The prediction models that were experimented with are shown in Table 1.

TABLE 1
Prediction Methods Implemented in the Image-based Prediction System

| Method | Description |
|---|---|
| M1 | OI + LBP(uniform) + MF + SVR |
| M2 | OI + LBP(nri_uniform) + MF + SVR |
| M3 | EI + GP + LBP(uniform) + MF + SVR |
| M4 | EI + GP + LBP(nri_uniform) + MF + SVR |
| M5 | EI + Pre-trained CNN + MF + SVR |
| M6 | OI + Trained CNN |

To exam the effect of image preprocessing step, texture features were extracted from the original active region image and the preprocessed sensor image. The enhanced sensor active region image was denoted as EI, and the original sensor image was denoted as OI.

In addition to the texture features, the manufacturing factors (MF) were added to the feature vector as input to the prediction system based on the SVR model. The manufacturing factors included the average measured sensor thickness data and three process control parameters, which were solid content, line speed, and flow rate. Each manufacturing factor was a floating-point number and normalized in range [0, 1].

The uniform method LBP generated a 10-element 1D feature array by setting P=8 and R=3. The feature array was then normalized such that the sum of the elements in the array was one. The nri_uniform method LBP generated a 58-element 1D feature array under the same setting. The Gaussian pyramid (GP) contained three layers. Hence, applying the LBP method on each GP layer generated a 1D feature array three times longer.

Another approach to extract the feature vector was learned from the pre-trained CNN model. The same architecture, ResNet-34, was used here as discussed above. The feature vector was a 512-element 1D array that outputs from the last average pooling layer.

The RMSE was used to evaluate the accuracy of the predicted sensor performance for each fold. In Equations 4 and 5, the average RMSE and the standard deviation of RMSE are used to estimate the performance of the image-based prediction system.

$${RMSE}_{predict} ( mV ) = \sqrt{\frac{1}{N} {\sum }_{x} {( {V}_{fit} ( x ) − {V}_{fit}^{′} ( x ) )}^{2}} \qquad ( 4 )$$

$${RMSE}_{predict} ( \% ) \sqrt{{\frac{1}{N} {\sum (}_{x} \frac{{V}_{fit} ( x ) − {V}_{fit}^{′} ( x )}{{V}_{fit} ( x )} )}^{2} \times 100 \%} \qquad ( 5 )$$

TABLE 2
Prediction Results

| | RMSE | RMSE | StDev | StDev |
|---|---|---|---|---|
| Method | (mV) | (%) | (mV) | (%) |
| M1 | 6.00 | 8.24 | 1.31 | 2.59 |
| M2 | 5.91 | 8.06 | 1.49 | 2.67 |
| M3 | 5.69 | 7.75 | 0.74 | 1.45 |
| M4 | 5.87 | 7.98 | 1.53 | 2.79 |
| M5 | 5.81 | 8.12 | 1.62 | 3.01 |
| M6 | 6.22 | 9.15 | 0.87 | 1.68 |

The accuracy and the robustness of the image-based prediction system can be described by the average RMSE and the standard deviation shown in Table 2. M1 and M5 are the prediction models. The texture features extracted using different LBP method alone and then fused with MF does not make a noticeable difference by comparing M1 and M2. Texture features extracted using the combinational method help improved the accuracy of the prediction system by comparing M1 with M3 and M2 with M4. The results show that the preprocessed sensor image and the Gaussian pyramid method improved the performance of the system. M3 achieved the best performance among all six models, which means applying the LBP method on the Gaussian pyramid of the preprocessed sensor image appeared to improve the performance of the prediction system. The result also verified the correctness of the physics-based model.

### CONCLUSION

To monitor the sensor quality during the fabrication process with a R2R system in real-time, the image-based prediction system was developed to accurately predict the potentiometric response of the nitrate sensor given preprocessed sensor active region images. A novel way of segmenting the active region from the noncontact sensor image was introduced to prepare the image dataset for the prediction system. The active region sensor images were preprocessed before being fed into the prediction system to enhance the texture feature that appeared on the sensor surface. The physics-based model suggested a logarithmic relationship between time and the potentiometric response in the saturated phase, which helped generate the ground truth dataset. The LBP descriptor, Gaussian pyramid method, and pre-trained CNN model were used to extract texture features from the preprocessed active region images. Feature vector, one of the inputs to train the SVR based prediction system, was generated by appending the extracted image feature with the normalized manufacturing factors. Both machine learning and deep learning approaches were implemented to realize the prediction system.

### Adaptive Learning-Based Method for Nitrate Sensor Quality Assessment in On-Line Scenarios

In a second investigation, an image-based on-line assessment system was proposed to monitor the quality of nitrate sensors in real time and provide manufacturing information. In a previous investigation, an imaging system was designed to capture the roughness of a nitrate sensor's active region. The existing relationship between the sensor performance metrics and the 2D images of the ISM regions was verified in a nitrate sensor and automatic systems were developed to predict sensor performance based on the captured active-region images. As the development of the deep neural networks, many influential network structures were adopted in image-based approaches for classification, regression, and segmentation. Due to high-performance optimization techniques and the well-built datasets that contain extensive quantity data and high-quality label, learning-based method achieved promising results if the dataset is static. Therefore, the Convolutional Neural Networks (CNN) based approach was proposed to predict the large-scale 1D array of performance curves for better assessing the nitrate sensor's quality. Although this CNN model achieved promising results, it is an off-line learning method that trains on the static dataset and cannot adapt to new situations, e.g., assess sensors from new manufacturing settings.

Preparing a sufficient dataset for variant manufacturing setting is not always feasible in manufacturing scenarios and limit the practicality of off-line learning methods. Industry often needs a more adaptive approach to training and inference the data in sequence. However, tuning the deep CNN model in on-line scenario requires sufficient time for convergence. The shallow layer's parameters change slowly due to the vanishing gradient. To address this problem, the Hedge Backpropagation (HBP) has been proposed to help the gradient backpropagate to a shallow layer and embed the dynamic depth concept to improve the classification network's on-line learning performance. However, this investigation is for classification tasks, and the Fully Connected (FC) network is not efficient in on-line settings. In this investigation, the Fully Connected HBP network was implemented for sensor assessment purposes. Also investigated was the ResNet, an influential network structure that could benefit on-line setting adaptation. Finally, the HBP concept was embedded in ResNet and an on-line assessment network was developed that accurately predicted the sensor's quality and could adjust to new manufacturing settings efficiently.

### Sensor Performance Prediction in On-Line Scenarios

### Sensor Performance Data

To represent the sensor's performance, the temporal potentiometric voltage response was recorded in specific nitrate solutions for about one day. Therefore, the system was expected to predict the performance curve as time increases, which is a large-scale 1D array and includes around 2k elements, for real-time assessment. However, the raw data includes inevitable noise from the manual measurement. The challenge was that it is not reliable to predict a sensor performance's raw data only based on 2D images. Thus, a curve fitting system was applied to reconstruct the temporal potentiometric voltage response from the measured data. An average filter was applied with a 30-length sliding window on Vm(t) (the raw data as a function of time) to eliminate the noise. Since the time intervals were different from measurement, the smoothed curve was downsampled to 100 data points to keep the same length. Only the last 80% of down-sampled data points were selected for the potentiometric response in the saturated phase.

According to the ion transport equation, the potentiometric response grows logarithmic with increasing time in the ideal case. Thus, the fitting model is a logarithm curve, as shown in Equation 6 below. The Levenberg-Marquardt algorithm was used to optimize the parameters of the fitting model, a and b. The optimized model parameters dominate the shape of the temporal sensor performance data of the nitrate sensor. The fitted logarithmic curve V_{fit} will be treated as the system's prediction target. Regression models can be applied to predict parameters of a and b based on image features.

$${V}_{fit} ( x ) = a log ( x ) + b \qquad ( 6 )$$

Prediction System with On-Line Settings

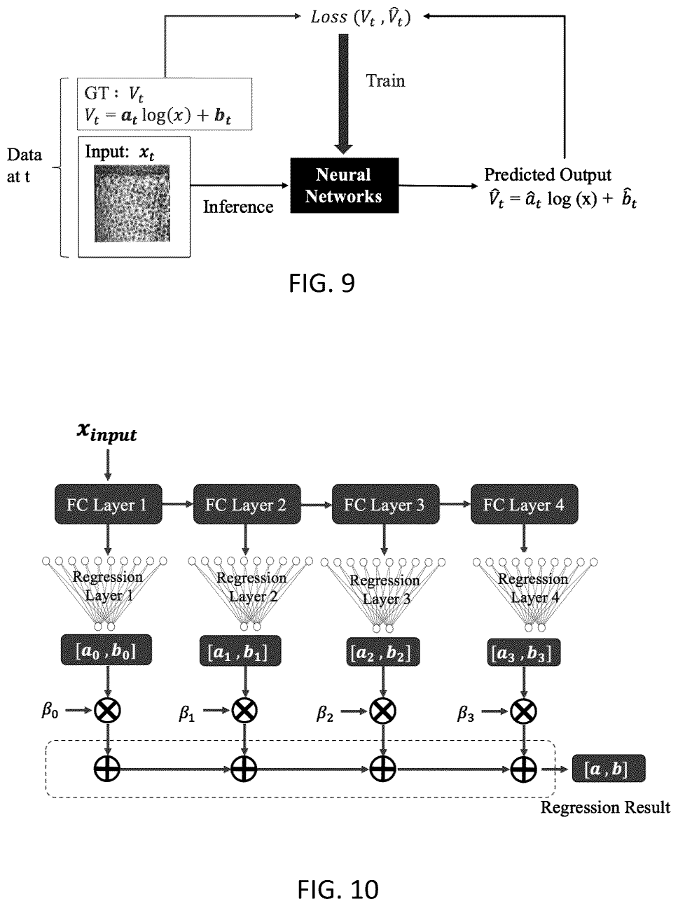

A previous investigation generated multiple regression models to predict the fitted curve based on off-line learning. Deep learning has shown its more powerful ability to represent useful features from images. The traditional machine learning system is very susceptible to the hyper-parameters to make the system hard to update in online settings. Thus, the finetuned CNN method was expected to extend to the prediction system in on-line scenarios. Off-line training optimizes the regression model by passing the training dataset multiple times. However, in on-line scenarios, the input data come sequentially. In the present investigation, the new fabricated sensor comes to the prediction model one by one to make a prediction and update the prediction system in the same iteration. FIG. 9 shows the on-line prediction process during nitrate sensor manufacturing. In each iteration (t), one new sensor data will be fed to the prediction model. xₜ an incoming new sensor's active-region image, and Vₜ with parameters aₜ and bₜ represents the corresponding fitted logarithm curve, which is the ground truth, at current iteration (t). The on-line prediction is based on the model generated at t. After the prediction, the loss between the current prediction and the ground truth data will be applied to update the prediction model for adapting new data characteristics.

### Proposed Method

In this investigation, the original Hedge backpropagation (HBP) network was modified for the online regression tasks. Also investigated was the backbone network structure and the ResNet, a network based on residual learning that can efficiently adapt to online scenarios, was chosen for online regression learning. An online learning network was designed based on ResNet and the embed the HBP's concept.

Fully Connected Network with Hedge Backpropagation

Hedge Backpropagation (HBP) provides shortcuts for gradient transmit, and dynamically selects the model's depth to improve the online classification performance. In this investigation, a concept was followed that implements a four-layer FC network, as shown in FIG. 10. The entire backbone network followed the conventional fully connected network design that all layers are in sequence and fully connected to the next layer. There is a non-linear activation function, ReLU, between two sequential layers to help the network learn high-level feature representation in different FC layers. The input image was first resized to 224×224×3 and then flattened as a 1-D vector and fed to the FC network. All FC layers in the network produced a 1,024-dimension feature vector. Unlike classical FC networks, the output of all four FC layers can be treated as feature maps for output regression. To meet regression requirements, the four regression layers, each containing two neurons to predict the a and b in Equation 6, were attached to all FC layers individually.

The final regression result was a weighted sum of all four layer's regression results. The weight parameter βi is also a trainable parameter optimized by Equation 7 (below). The loss L is computed based on Equation 8 and Equation 9. Both predicted (aₚ,bₚ) and ground-truth (a_{gt}, b_{gt}) were used. After each update, βi was normalized so that Σβi=1. In addition, the minimum βi boundary was controlled as s/L so that the βi would not be too small and ignored during the training process in the future. The L is the total number of FC layers, which was four. s was set as 0.2.

Therefore, based on current online training progress, the system will select the best parameter, βi. If the shallow layer's regression performance is better than that of the deep layer, the β corresponding to the shallow layer will be larger than other layers to improve the overall regression result. It is worth mentioning that the depth of the network is dynamic due to the varying weight parameter βi. In this investigation, an Adam optimizer was chosen to update all parameters in the model except βi.

$${β}_{i}^{( t + 1 )} = {β}_{i}^{( t )} {γ}^{L} \qquad ( 7 )$$

$$L ( ( {a}_{p} , {b}_{p} ) , ( {a}_{g t} , {b}_{g t} ) ) = RMSE ( F ( {a}_{p} , {b}_{p} ) , F ( {a}_{g t} , {b}_{g t} ) ) \qquad ( 8 )$$

$$F ( a , b ) = a log ( x ) + b for x = 20 , 21 , … , 99 \qquad ( 9 )$$

### ResNet for Online Learning

Convolutional Neural Network (CNN) is commonly adopted in the image-based approach due to the convolutional kernel, and pooling layers can learn both the local feature and global feature of the image and much more efficient than conventional FC layers. Although deep CNN models, which contain many more parameters, commonly outperform shallow models, they suffer from many convergence issues, e.g., gradient vanishing and training time consumption. For example, consider a simple network with L layers. Based on the chain rule, the loss backpropagate to the first layer needs to multiply the partial derivative L times. If all partial derivatives are smaller than 1, the final gradients returning to shallow layers will become small and make small changes on shallow layers. To overcome this issue, deep neural networks trained on static datasets usually consume meaningful time for convergence.

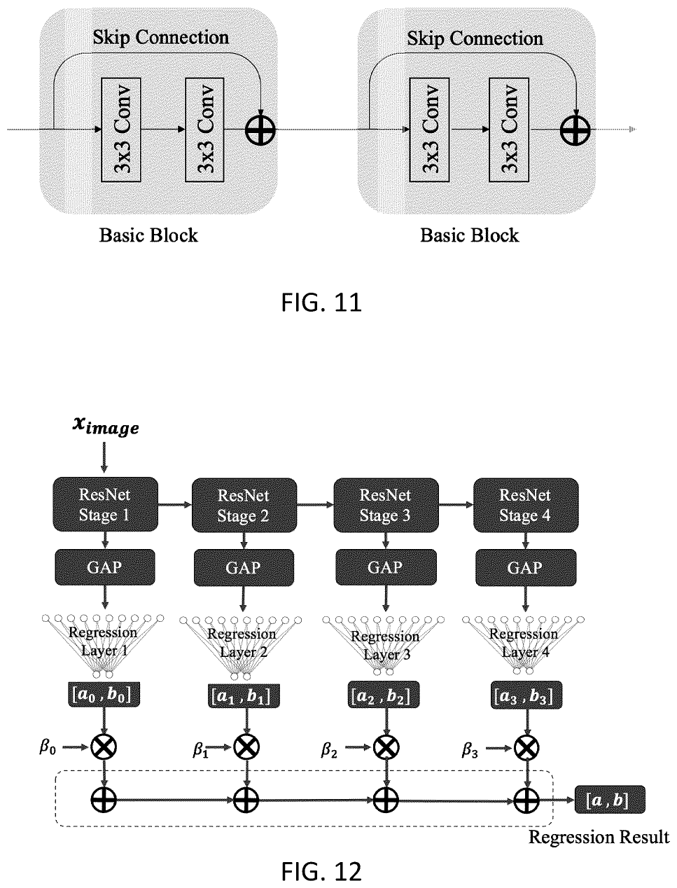

An online learning model, trained on the data in sequential order, could not provide sufficient time for convergence of the deep network, such as VGG. However, a residual learning proposed in the literature inserts a skip connection between each block of convolutional layers. As shown in FIG. 11, those connections provide shortcuts for gradient propagation to reduce the convergence time of the shallow layers. Therefore, ResNet is a potentially good backbone network choice for online learning. In this investigation, the ResNet was first trained on the offline dataset and then applied under the online learning scenario. In other words, the ResNet will take a single new sensor image in sequence and tuned itself with this image for several cycles. A small learning rate was chosen during the online training to avoid overshooting. Also, the number of cycles was controlled to get optimal performance.

ResNet with Hedge Backpropagation

Although the residual learning helps the ResNet transmit gradient from the deep layer to the shallow layer, the fixed depth limited its online learning performance. In this investigation, the Hedge Backpropagation's dynamic depth concept was implemented and combined with the ResNet-34 for online sensor image assessment. As shown in the FIG. 12, the conventional ResNet could be split into four stages, and each generated feature maps with a different number of channels. As shown in Table. 1, the ResNet-34 in this investigation had 256-d, 512-d, 1024-d, and 2048-d feature maps. A stride convolutional layer between two stages was used to downsample the feature map and increase the receptive area of convolutional kernels. Therefore, the ResNet could learn more global features from the image.

TABLE 1
Feature map dimension of four stages of ResNet-34.

| | Dimension |
|---|---|
| Stage 1 | 56 × 56 × 256 |
| Stage 2 | 28 × 28 × 512 |
| Stage 3 | 14 × 14 × 1024 |
| Stage 4 | 7 × 7 × 2048 |

To apply those intermediate layers' feature maps for regression, a global average pooling layer was inserted at the end of each stage to summarize the feature maps as feature vectors. Regression layers with two neurons fully connect to each feature vector for assessment parameter regression. The final regression result was a weighted sum of four regression outputs of all stages. Following Equation 2, the weight parameter βi was also a trainable parameter. All of βi was be normalized after each updating and had a minimum boundary s/L. Adam was chosen to update all other parameters in the model.

### Experiments

Datasets of fabricated nitrate sensors from different manufacturing runs were used to evaluate the proposed on-line learning methods. The data in the on-line dataset was fed to the on-line prediction system one by one. The evaluation was embedded in the on-line training process. The initials of the prediction models were generated by fine-tuning neural networks on an off-line dataset. The off-line dataset included the data that has been seen before manufacturing.

### Dataset Preparation

The nitrate sensor dataset included the active-region images of the nitrate sensors and the measured potentiometric response. An imaging system was used to capture the roughness of the ion selective membrane and apply edge detection to crop the active region and eliminate the effects of background. The detecting system was generated in real time and can embed after the on-line camera system. In addition, the corresponding sensor performance was measured in 0.001 M nitrate solutions for about 24 hours. The performance metric was the difference between the potential voltages of the target membrane and the reference sensor.

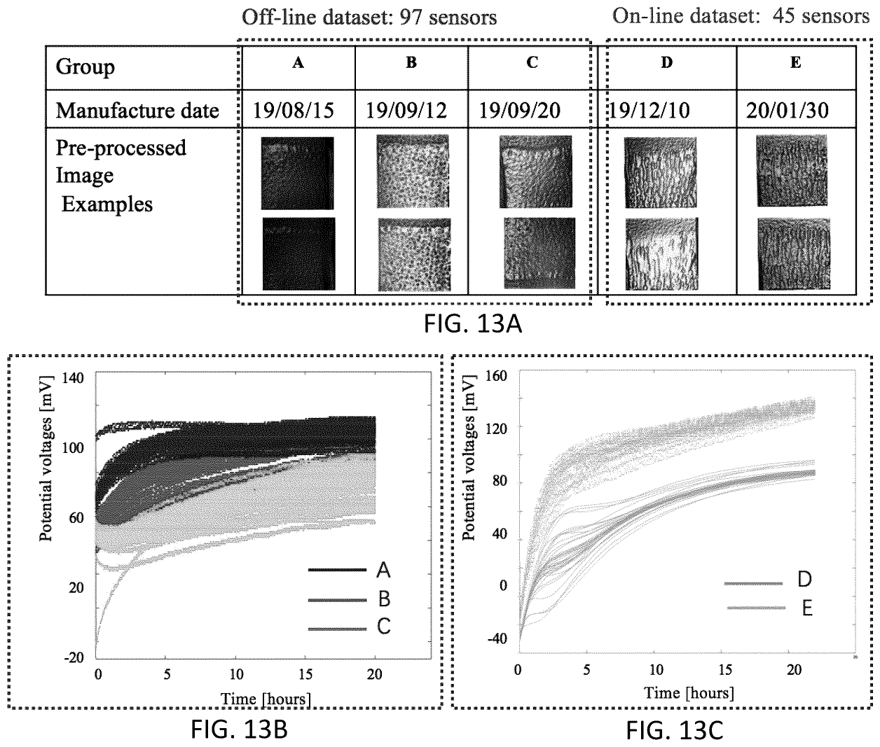

FIGS. 13A, 13B, and 13C represent an obtained nitrate sensor dataset. Since the thin-film nitrate sensors were manufactured on different manufacturing dates with varying manufacturing factors, the sensor data was grouped by the manufacturing runs. The dataset was separated as the off-line dataset and on-line dataset to mimic the manufacturing process: The off-line dataset included three earlier groups (Groups A, B, and C) with 97 sensors; and the on-line dataset included two alternative groups (Groups D and E) with 45 sensors. FIG. 13A shows examples from each group for the captured active-region images as judged by visual perception. FIGS. 13B and 13C show that their potentiometric response also grew with different behaviors. The off-line dataset (Groups A, B, and C of FIG. 13B) will be used to fine-tune the neural networks for the initials of on-line learning networks. Then, the on-line dataset (Groups D and E of FIG. 13C) will be fed to prediction systems with on-line settings.

As noted above, the curve fitting method was applied to all the measured performance data. The fitted logarithm curve V_{fit}(x) as a function of increasing time points was treated as the ground truth or the prediction target. The average root mean square error (RMSE) of the fitted curve V_{fit}(x) and the downsampled curve V_{d}(x) among the entire dataset was 1.39%. It was concluded that the fitted curve can depict the original measurement.

### Base-Line Experiments

The proposed architectures, HBP, ResNet, and ResNet with HBP, were applied to predict the sensor performance curve with off-line settings. The off-line dataset was used in training and the on-line dataset was used in the inference part. In the training process, 90 sensors were randomly selected for training and the remaining 7 sensors were selected for validation to prevent overfitting problems. In the implementation of the ResNet-34 model, pre-trained weights were used that were trained on ImageNet, as initials to help faster converge in training. After 2k epochs, both training loss and validation loss with the three models converged and became stable. Table 2 shows the results of training, validation, and inference loss with the three methods. There is a gap between the different manufacturing runs. The test dataset was from different manufacturing runs with the training set. The large gap between the different manufacturing runs limited the accuracy in off-line settings. Thus, the testing losses were much higher than the validation loss.

TABLE 2
Loss in training, validation, and inference in three
methods with off-line settings.

| | Train Loss | Validation | Test Loss |
|---|---|---|---|
| Method | [mV] | Loss [mV] | [mV] |
| ResNet + BP | 1.63 | 7.98 | 21.69 |
| FC + HBP | 3.34 | 8.76 | 30.90 |
| ResNet + HBP | 5.14 | 6.93 | 23.95 |

### Evaluation Metrics of On-Line Learning

The initial weights of the three methods were generated by fine-tuning the networks on the off-line dataset to efficiently adapt the new sensor data. In the on-line prediction, the on-line dataset with 45 sensors came to the prediction model one by one. In each iteration, the current prediction's loss backpropagated the model and updated the neural network multiple times for more accuracy. The number of cycles need to be optimized and updates modeled within each iteration for achieving more accurate and preventing overfitting problems. The evaluation system for on-line learning is inserted at the start of each iteration. The RMSE was applied to quantify the prediction error. Equation 10 shows the calculation of the RMSE at t-th iteration. The total time cost was also essential metric to evaluate the efficiency of our prediction model.

$$R M S {E}_{t} = \sqrt{\frac{1}{N} {\sum }_{x = 20}^{99} {( {V}_{t} ( x ) − {\hat{V}}_{t} ( x ) )}^{2}} \qquad ( 10 )$$

$${RMSE}_{A V G} = \frac{{\sum }_{t = 1}^{T} {RMSE}_{t}}{T} for T = 45 \qquad ( 11 )$$

### Results and Discussion

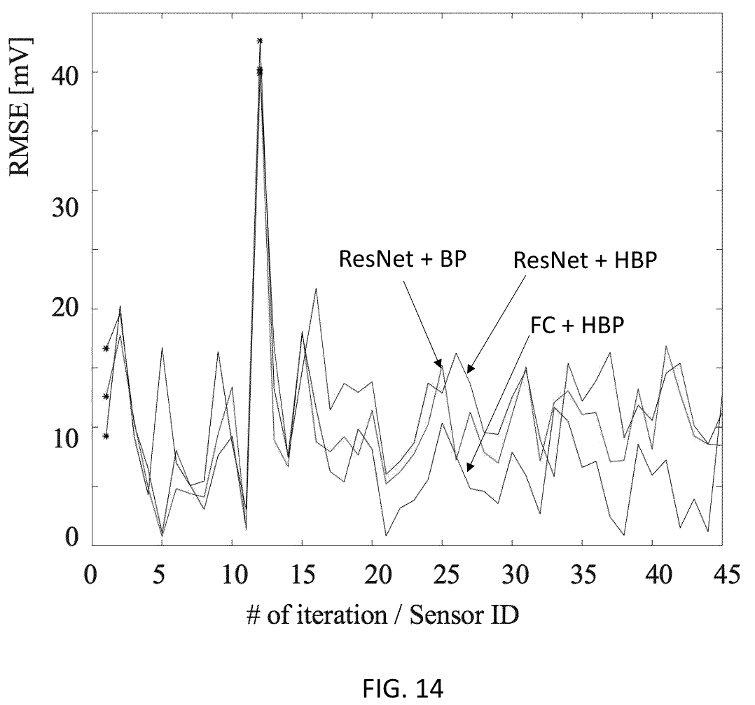

In the on-line learning experiment, the evaluation and training process was simultaneous. To compare three methods' adaptive abilities, optimal numbers of cycles were implemented to achieve the best performance for each model. FIG. 14 shows the RMSE of the prediction with new data coming in each iteration. The RMSE suddenly increased when the sensor from an unseen manufactured run coming into the prediction model. Then, the prediction errors descended within one iteration. Table 3 compares the average RMSE, which is shown in Equation 11, and the time cost for each coming new sensor in the on-line training process. According to the results, FC layers with hedge backpropagation obtained the smallest prediction error with the on-line settings. The HBP optimization method was more suitable for the desired on-line prediction task. However, the training process of FC layers cost much more time than the ResNet architectures due to the large amounts of parameters in the FC layers. The proposed method of leveraging the ResNet architecture with HBP optimization also achieved higher accuracy than the method of ResNet with conventional backpropagation. On the other hand, it also largely reduced the training time than the model of stacking FC layers. The proposed method leveraged residual learning's efficient architecture to keep updating the prediction model in real time. Also, it applied the novel optimization method of the HBP to achieve higher accuracy during the on-line prediction.

TABLE 3
Results of RMSE and computation time in on-line
prediction among three methods.

| | # of cycles | RAISE_{AV G} | Time cost |
|---|---|---|---|
| Method | per sensor | [mV] | [seconds per sensor] |
| ResNet + BP | 30 | 11.76 | 1.20 |
| FC + HBP | 35 | 8.18 | 77.01 |
| ResNet + HBP | 20 | 10.06 | 4.91 |

### CONCLUSION

The FC+HBP network structure achieved the best assessment performance, but required time for tuning. Both ResNet-34 network structures with conventional backpropagation (ResNet+BP) and HBP (ResNet+HBP) were able to assess a sensor's performance in real-time. Due to the advantages of HBP, the ResNet+HBP may provide better assessment performance than ResNet+BP. The ResNet+HBP not only used the HBP for better on-line assessment performance, but also can be efficiently adapted to new manufacturing settings benefit from the ResNet's structure.

### Metrology System for Roll-to-Roll Monitoring of Structural/Functional Uniformity in Z Oriented Micro/Nanocomposite Films

As previously noted, besides predictions on images of a surface to capture surface roughness, other on-line measured data, such as coating thickness and electrical properties, can be measured to help guide manufacturing in real time. A particular example pertains to the use of electric and magnetic fields to organize nano or micro columns of dielectric and magnetic particles in a polymer matrix precursor using a R2R manufacturing system 10, such as schematically represented in FIG. 15. In such a process, functional particles/phases 12 are premixed with a matrix 14 of a polymer precursor to form a composite film 16 that is cast onto a carrier 18 (Zone 1). As the resulting composite film 16 proceeds along the machine direction, it enters an electrical or magnetic field 20 (Zone 2) that facilitates the formation of columns 22 of the particles 12 oriented in the field (thickness direction of the film 16) while the matrix 14 remains at a low viscosity. The composite film 16 cures as it proceeds through Zone 2. In the nonlimiting example of FIG. 15, curing is represented as performed by heating with an air heater 24, though UV curing, solidification by cooling, or solidification by another mechanism are also within the scope of the embodiment. When the composite film 16 exits Zone 2, it may be mostly or entirely solidified to preserve the “Z” orientation of the particle columns 22 within the film 16. Zone 3 can affect completion of the solidification by any further appropriate treatment.

FIG. 16 schematically represents a metrology tool 30 that can be implemented to assess local density of the columns 22 created within the composite film 16 by the process of FIG. 15. Because the columns 22 can comprise different materials than the matrix 14 of the composite film 16, the material of the columns 22 can be chosen to exhibit different properties, as a nonlimiting example, thermal properties such as thermal conductivity. In this example, a “line of heat” is locally and continuously generated in a heating zone 32 where the composite film 16 is gently heated, for example, using a rasterizing laser source 34. A high-resolution line scan IR camera 36 may be used to measure the temperature in a measurement zone 38 that is downstream from the heating zone 32. Since the columns 22 are vertically oriented in the film 16 and surrounded by the matrix 14 that has lower thermal conductivity, variations in local temperature result, which can be continuously recorded to generate a heat profile that can be converted to local structure distribution for quality control purposes.

While the invention has been described in terms of particular embodiments and investigations, it should be apparent that alternatives could be adopted by one skilled in the art. For example, the invention is applicable to devices and components thereof and the use of equipment that differ in appearance and construction from the embodiments described herein and shown in the drawings, functions of certain components of such equipment and devices could be performed by components of different construction but capable of a similar (though not necessarily equivalent) function, process parameters could be modified, and appropriate materials could be substituted for those noted. As such, it should be understood that the intent of the above detailed description is to describe the particular embodiments represented in the drawings and certain but not necessarily all features and aspects thereof, and to identify certain but not necessarily all alternatives to the particular embodiments represented in the drawings. Accordingly, the invention is not necessarily limited to any embodiment described herein or illustrated in the drawings. It should also be understood that the purpose of the above detailed description and the phraseology and terminology employed therein is to describe the illustrated embodiments represented in the drawings, as well as investigations relating to the particular embodiments, and not necessarily to serve as limitations to the scope of the invention. Finally, while the appended claims recite certain aspects believed to be associated with the invention as indicated by the investigations cited above, they do not necessarily serve as limitations to the scope of the invention.

1. A method of monitoring a performance characteristic of printed devices during fabrication of the printed devices in a high-speed process, the method comprising:
developing a physics-based model of at least a first component of the printed devices;
fabricating the printed devices with the high-speed process using fabrication steps that comprise depositing the first components;
acquiring a physical characteristic of a plurality of the first components of a plurality of the printed devices following the depositing of the first components;
predicting a performance characteristic of the printed devices based on the physics-based model of the first component and the physical characteristic acquired of the plurality of the first components; and then
modifying at least one of the fabrication steps performed during the fabricating of a subsequently-fabricated group of the printed devices to adjust the performance characteristic of the subsequently-fabricated group of the printed devices.

2. The method according to claim 1, wherein the printed devices are pressure sensors and the first components are pressure diaphragms.

3. The method according to claim 1, wherein the acquiring of the physical characteristic of the plurality of the first components comprises obtaining a measurement of the physical characteristic.

4. The method according to claim 3, wherein the measurement is chosen from the group consisting of capacitance, confocal, Eddy current, density, thickness, dielectric constant, conductivity, spectroscopic reflectance, and ellipsometric parameters of the plurality of the first components.

5. The method according to claim 1, wherein the modified fabrication step performed during the fabricating of the subsequently-fabricated printed devices is a treatment parameter of the first components.

6. The method according to claim 5, wherein the treatment parameter is chosen from the group consisting of drying parameters, annealing parameters, sintering parameters, heat treatment parameters, and curing parameters.

7. The method according to claim 1, wherein the modified fabrication step performed during the fabricating of the subsequently-fabricated printed devices is adjusting the printing speed during the sheet-to-sheet manufacturing or the web speed of the moving substrate during the roll-to-roll manufacturing of the first components.

8. The method according to claim 1, wherein the high-speed process is performed on a roll-to-roll or sheet-to-sheet system.

9. A method of monitoring a performance characteristic of printed devices during fabrication of the printed devices in a high-speed process, the method comprising:
developing a physics-based model of at least a first component of the printed devices;
fabricating the printed devices with the high-speed process using fabrication steps that comprise depositing the first components;
acquiring a physical characteristic of a plurality of the first components of a plurality of the printed devices following the depositing of the first components, wherein the step of acquiring comprises imaging a surface of the plurality of the first components to obtain images thereof and identifying and separating an image area of interest of the first components from the images from other areas of non-interest of the images using template matching;
predicting a performance characteristic of the printed devices based on the physics-based model of the first component and the physical characteristic acquired from the image area of interest of the plurality of the first components; and then
modifying at least one of the fabrication steps performed during the fabricating of a subsequently-fabricated group of the printed devices to adjust the performance characteristic of the subsequently-fabricated group of the printed devices.

10. The method according to claim 9, wherein the printed devices are pressure sensors and the first components are pressure diaphragms.

11. The method according to claim 9, wherein the acquiring of the physical characteristic of the plurality of the first components comprises obtaining a measurement of the physical characteristic.

12. The method according to claim 11, wherein the measurement is chosen from the group consisting of capacitance, confocal, Eddy current, density, thickness, dielectric constant, conductivity, spectroscopic reflectance, and ellipsometric parameters of the plurality of the first components.

13. The method according to claim 9, wherein the modified fabrication step performed during the fabricating of the subsequently-fabricated printed devices is a treatment parameter of the first components.

14. The method according to claim 13, wherein the treatment parameter is chosen from the group consisting of drying parameters, annealing parameters, sintering parameters, heat treatment parameters, and curing parameters.

15. The method according to claim 9, wherein the modified fabrication step performed during the fabricating of the subsequently-fabricated printed devices is adjusting the printing speed during the sheet-to-sheet manufacturing or the web speed of the moving substrate during the roll-to-roll manufacturing of the first components.

16. The method according to claim 9, wherein the template matching comprises inspecting the images and locating areas that best match an object presented in a template image.

17. The method according to claim 9, wherein the high-speed process is performed on a roll-to-roll or sheet-to-sheet system.

18. A method of monitoring a performance characteristic of printed devices during fabrication of the printed devices in a high-speed process, the method comprising:
developing a physics-based model of at least a first component of the printed devices;
fabricating the printed devices with the high-speed process using fabrication steps that comprise depositing the first components;
imaging the first components of at least some of the printed devices following the printing of the first components to obtain images of a plurality of imaged first components associated with a plurality of imaged printed devices of the printed devices;
predicting a performance characteristic of the imaged printed devices based on the images of the imaged first components and the physics-based model of the first component; and then
modifying at least one of the fabrication steps performed during the fabricating of a subsequently-fabricated group of the printed devices to adjust the performance characteristic of the subsequently-fabricated group of the printed devices.

19. The method according to claim 18, wherein the images of the plurality of the first components are of a surface of the plurality of the first components and capture surface roughnesses or microstructures of the surfaces thereof.

20. The method according to claim 18, wherein the high-speed process is performed on a roll-to-roll or sheet-to-sheet system.
